(19) United States
(12) Patent Application Publication
(10) Pub. No.: US 2012/0301067 A1
(43) Pub. Date: Nov. 29, 2012

(54) APPARATUS AND METHODS FOR FORMING KINEMATIC COUPLING COMPONENTS

(76) Inventor: Christopher J. Morgan, Lexington, KY (US)

(21) Appl. No.: 13/329,391

(22) Filed: Dec. 19, 2011

Related U.S. Application Data
(63) Continuation of application No. PCT/US10/39221, filed on Jun. 18, 2010.
Application No. PCT/US10/39221 is a continuation-in-part of application No. PCT/US09/54900, filed on Aug. 25, 2009.
(60) Provisional application No. 61/269,038, filed on Jun. 19, 2009.
(60) Provisional application No. 61/269,984, filed on Jun. 30, 2009.
(60) Provisional application No. 61/190,177, filed on Aug. 26, 2008.

(51) Int. Cl. F16C 19/00

(52) U.S. Cl. 384/590

(57) ABSTRACT

In one aspect, an apparatus for use in forming a kinematic, or quasi-kinematic, coupling having at least one component including a plate adapted for carrying a plurality of bearing elements comprises a template including a plurality of supports adapted for engaging and assisting in aligning the plurality of bearing elements relative to the plate of the component. The template may be used in forming either a top or base of the coupling. The top may further be adapted to be inverted relative to the base, which may also include bearing elements for receiving bearing elements associated with the top. A further embodiment relates to using a first template adapted to form a first component to create a second template adapted to form a second component. Another embodiment relates to creating a base adapted for engaging a top on two opposing sides. Related methods are also disclosed.

This application claims the benefit of U.S. Provisional Patent Application Ser. No. 61/269,038, filed Jun. 19, 2009, and U.S. Provisional Patent Application Ser. No. 61/269,984, filed Jun. 30, 2009. The disclosures of these provisional applications are incorporated herein by reference.

### TECHNICAL FIELD

The present invention relates to the art of precision manufacturing and, more particularly, to forming components for use in connection with quasi-kinematic or kinematic couplings.

### BACKGROUND OF THE INVENTION

In its most basic form, a kinematic coupling is a device comprised of two plates, one fixed (the base) and one that is portable or removable (the top). The main feature of a kinematic coupling is the ability of the top to be separated from the base and then to be precisely returned to the base. A kinematic coupling achieves this by constraining all six degrees of mechanical freedom between the base and top with exactly six Hertzian contact points.

Kinematic couplings are typically used in manufacturing processes and are particularly useful in those where precision, or repeatability, is essential. In the present art, high precision exists only between a single unique kinematic coupling base/top pair. When one places a different coupling top on the same base, the position of the bearing elements on the new coupling top is different with respect to the base. That is, coupling tops are not accurate with respect to one another although the position of each top with respect to a given base is precise, or repeatable; it is not, however, accurate. (Correspondingly, the same result holds true if one were to exchange bases rather than tops.) This uniqueness means the tops (and correspondingly, bases) are not interchangeable.

In the present art, interchangeability between different coupling tops and bases without a loss of positional accuracy has been a long-standing problem. Interchangeability with high accuracy is desirable in fields such as micromanufacturing, micromachining, micromolding, precision optics and precision engineering, to name but a few. Interchangeability in these fields is desirable so that multiple work-pieces can be mounted on different coupling tops and moved through manufacturing/metrology processes on a plurality of coupling bases while maintaining the accurate location of the work-piece with respect to each base. Interchangeable kinematic (and quasi-kinematic) coupling bases and tops would solve a longstanding problem in precision engineering and eliminate time consuming calibrations as is presently done, thereby enhancing manufacturing efficiency and overall accuracy of the production environment.

Past approaches to creating interchangeable kinematic couplings generally suffer from being very complex, extremely expensive and still do not sufficiently reach the touchstone of high accuracy in interchangeability. For example, some systems attempt to create accurate interchangeability using complex measurement and calibration systems. This results in a loss of production efficiency and leads to poor accuracy. Although the preceding mainly refers to kinematic couplings, it applies equally to quasi-kinematic couplings, which are likewise useful in production facilities.

Accordingly, there exists a need for an apparatus and method by which components for use in kinematic or quasi-kinematic couplings may be manufactured in a manner that promotes accurate interchangeability. As compared with past approaches, the resulting coupling should be relatively simple in construction and inexpensive to implement. In doing so, it would bring a significant level of advancement in terms of accuracy, reducing the cost of such couplings and reducing a manufacturer's processing costs in practice.

### SUMMARY OF THE INVENTION

An apparatus for forming a kinematic or quasi-kinematic coupling using a top including a plurality of first bearing elements comprises a base for coupling with the top, said base supporting a plurality of second bearing elements adapted for engaging the plurality of first bearing elements of the top, said base adapted to move in a constrained fashion in at least one direction while coupled to the top.

The base may comprise a plate having a second substantially planar surface substantially parallel to a second substantially planar surface of the top. Movement of the base is adapted to be singular, linear and generally orthogonal to the substantially planar surfaces. Preferably, a dynamic bearing provides the constrained movement. Most preferably, the dynamic bearing is connected to the base. The dynamic bearing may comprise a flexure.

The second bearing elements may have a curved surface for contacting a spherical surface of the corresponding first bearing elements. The second bearing elements may be fixed in position with a fixing agent. Pairs of the second bearing elements may be arranged in three groups, each group for associating with one of first bearing elements, and the groups are arranged in a triangular pattern.

An apparatus for use in forming a kinematic or quasi-kinematic coupling including a base comprises at least one top adapted for being removably associated with the base to form the coupling, the top including a generally triangular structure supporting a plurality of first bearing elements. Preferably, the first bearing elements project in a first direction relative to the top, and the top further includes a plurality of second bearing elements projecting in a second direction generally opposite the first direction. The first and second bearing elements may include generally spherical surfaces. The triangular structure may include at least one inwardly curved lateral side. The geometric centers of the first bearing elements may form an equilateral triangle.

An apparatus for forming a kinematic or quasi-kinematic coupling with first component having a plurality of first bearing elements and a second component including a plurality of second bearing elements. The apparatus comprises a third component having a first side adapted for engaging at least one of the first bearing elements of the first component and a second, opposite side adapted for engaging at least one of the second bearing elements of the second component. The first side includes a plurality of third bearing elements for engaging the first hearing elements, and the third bearing elements may include a generally curved surface. The third bearing elements may each comprise a partial cylinder having the generally curved surface for engaging the spherical surface of the first bearing element.

The second side of the third component may include a plurality of fourth bearing elements. Preferably, the plurality of third bearing elements generally form a triangle. The third component may comprise a dynamic bearing for permitting movement of the first or second component in a direction substantially orthogonal to a substantially planar surface of the first or second component. The third component may comprise a first plate connected to the second plate by the dynamic bearing. A fixing agent may be provided for fixing the third bearing elements to the first side.

An apparatus for forming first and second kinematic or quasi-kinematic couplings with first and second tops comprises a first base having a first side including a plurality of first bearing elements adapted for engaging the first top to form the first coupling and a second, opposite side adapted for engaging the second component to form the second coupling. The apparatus may further include a second base having a third side adapted for engaging the first or second top. The first base may include a dynamic bearing for permitting movement of the first or second top in at least one direction substantially generally orthogonal to a substantially planar surface of the first or second top.

An apparatus for forming first and second components of a kinematic or quasi-kinematic coupling, comprises a first template including a plurality of first supports, and a second template including a plurality of second supports adapted for engaging the first supports of the first template. The first template forms the first component and the second template forms the second component.

Preferably, each first support comprises at least three supports, each having a generally curved surface. The plurality of second supports may each include a generally spherical surface adapted for engaging the first supports. The apparatus may further include a bearing for movably supporting a portion of the second template including the second supports.

An apparatus comprises a first component for forming a kinematic coupling including a plurality of bearing elements positioned in radially extending apertures, each bearing element adapted for engaging at least one of the bearing elements of a second, opposing component. The first component may be tubular and include an opening in which the first bearing elements are positioned. The first bearing elements may include a generally spherical surface.

An apparatus comprises: a first component for forming a kinematic coupling including a plurality of first bearing elements, each first bearing element adapted for engaging at least one of the second bearing elements of a second, opposing component, the first bearing elements arranged in a manner that creates parallelism between a substantially planar surface on first component and a plane intersecting the geometric centers of the bearing elements, and the second bearing elements being machined in a surface of the second, opposing component. The second bearing element may comprise at least one flat surface.

An apparatus for forming a component of a kinematic or quasi-kinematic coupling, the component adapted for carrying a plurality of bearing elements comprises a template including a plurality of supports adapted for engaging and assisting in aligning the plurality of bearing elements relative to the at least one component of the kinematic coupling, at least one of the supports including at least one flat surface. The template may include at least two supports having at least three flat surfaces each. The template may comprise a plate, and the plurality of supports may be machined in the plate.

A method for forming abuse of a kinematic or quasi-kinematic coupling adapted for engaging a top including a plurality of second bearing elements comprises providing the base with a plurality of first bearing elements adapted for engaging the plurality of second bearing elements of the top, and providing a dynamic bearing adapted to allow the base to move in a constrained fashion in at least one direction while remaining coupled to the top. The method may further include the step of connecting the dynamic bearing to the base.

A method for forming multiple kinematic or quasi-kinematic couplings using a single base comprises removably associating a first top with a first side of the base to form the first coupling; and removably associating a second top with a second, opposite side of the base to form the second coupling.

A method of forming a base for a kinematic or quasi-kinematic coupling, comprises forming the base with a first side adapted for coupling with a first component of the coupling and a second side adapted for coupling with a second component of the coupling. The forming step comprises providing a first side of the base with a plurality of first bearing elements adapted for engaging the first component of the coupling, and providing a second side of the base with a plurality of second bearing elements adapted for engaging the second component of the coupling.

A method of forming first and second components of a kinematic coupling, comprises providing a first template for forming the first component, and using the first template to form a second template for forming the second component. The method further comprises the steps of using the first template to form the first component; and using the second template to form the second component. The using step may comprise using the first template to form a top of the coupling. The using step may comprise using the second template to form a base of the coupling.

An apparatus for use in forming a quasi-kinematic coupling including a base, comprises at least one top adapted for being removably associated with the base to form the coupling, the top including two spherical surfaces and a planar surface, said surfaces arranged to form the quasi-kinematic coupling with the base.

### BRIEF DESCRIPTION OF THE DRAWINGS

FIG. 1a is a perspective view of a kinematic coupling according to one aspect of the disclosure;

FIG. 1b is a partially exploded view of the kinematic coupling of FIG. 1a;

FIGS. 2a and 2b illustrate a template for forming a kinematic coupling top;

FIG. 3 illustrates the template of FIGS. 2a and 2b for forming a coupling top;

FIGS. 4a and 4b are perspective and top views of a template for use in forming a coupling base;

FIG. 5 illustrates the template of FIGS. 4a and 4b for forming a kinematic coupling base;

FIGS. 6 and 7 show an alternate embodiment of a top for forming a coupling;

FIGS. 8 and 9 show a further embodiment of a base for forming a coupling;

FIG. 10 illustrates a method of using a top as a template for forming a base of a coupling;

FIGS. 11-15 illustrate a coupling with a base adapted to provide a single degree of freedom;

FIGS. 16-20 show a two-sided base for fanning a coupling with a plurality of tops;

FIGS. 21-24 illustrate apparatus and methods for forming a two-sided top;

FIGS. 25-31 illustrate a two-sided base and the coupling that may result; and

FIGS. 32 and 33 show an alternative embodiment of a top constructed with radial holes for mounting the bearing elements;

FIGS. 34 and 35 show an alternative embodiment of a base with flat, machined bearing elements and a sufficiently flat surface;

FIG. 36 shows an alternative approach for providing interchangeable tops with a template including machined flats;

FIG. 37 shows an alternative embodiment of a two-sided kinematic coupling design with a two-sided top and two bases, one with flat, machined bearing elements and the other base having a flexural bearing;

FIGS. 38, 38a-38c, and 39 show an alternative embodiment for a kinematic coupling base with machined flats and a flexural bearing;

FIG. 40 show an alternative embodiment for a top template constructed of flat, machined machined supports arranged in a triangle;

FIGS. 41a and 41b relate to an alternative embodiment for a top template constructed of flat, machined supports comprising two clusters of three flats and a generally flat surface;

FIGS. 42-44 show an alternative embodiment for a quasi-kinematic coupling comprising atop made with two spherical bearing elements and one flat surface bearing element, and a base consisting of two cylindrical hearing elements and one flat surface bearing element;

FIG. 45 is an alternative embodiment of a template for forming an interchangeable, quasi-kinematic coupling top;

FIG. 46 is an alternative embodiment for a quasi-kinematic coupling base comprising a flexural bearing element with a single, linear degree-of-freedom; and

FIG. 47 is an alternative embodiment of a quasi-kinematic coupling with a top and base including a flexural bearing.

### DETAILED DESCRIPTION OF INVENTION

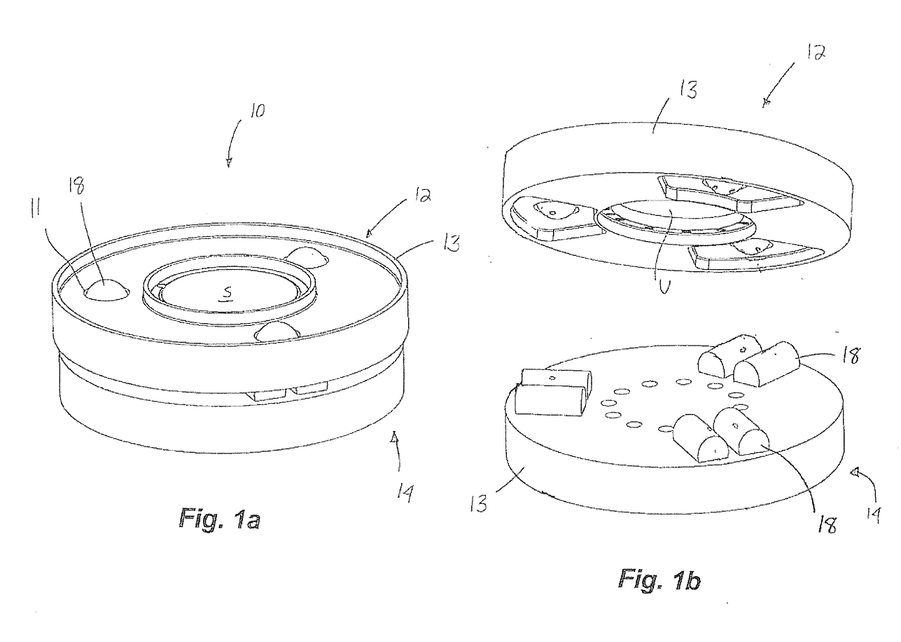

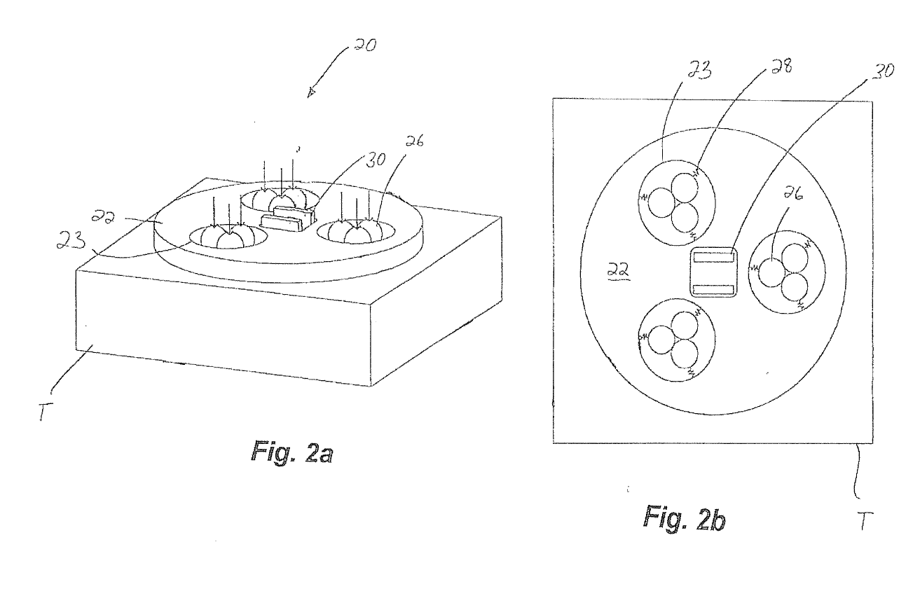

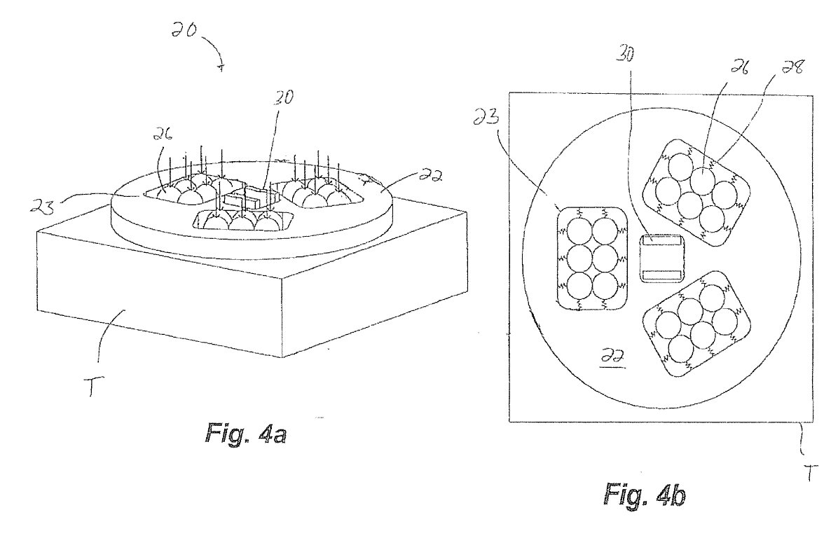

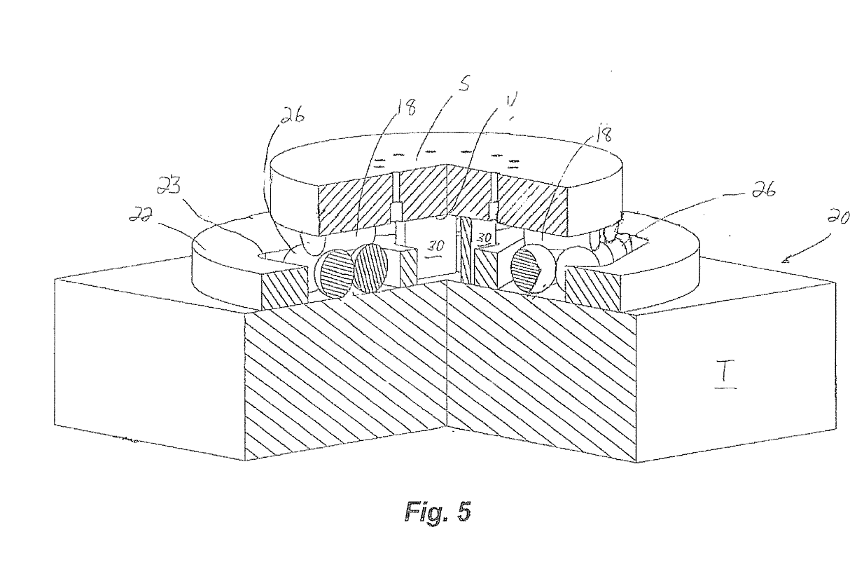

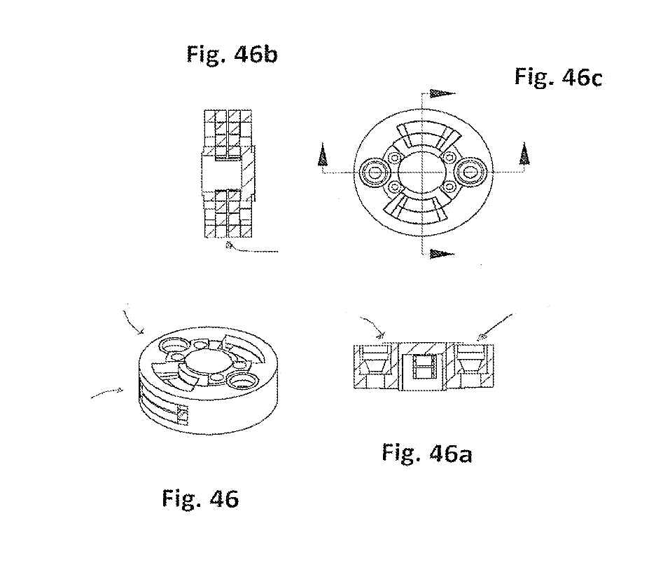

One embodiment is a kinematic coupling (10) that maintains precision and accuracy while being interchangeable with a plurality of tops and bases as illustrated in FIGS. 1a and 1b. An interchangeable kinematic coupling top (12) is fabricated by the template (20) illustrated in FIGS. 2a and 2b. Likewise, an interchangeable kinematic coupling base (14) is fabricated by the template (20) illustrated in FIGS. 4a and 46. For purposes of this disclosure, a template comprises a device used in creating the top or base of the kinematic or quasi-kinematic coupling.

In this embodiment six points of Hertzian contact are utilized, which necessarily results in the kinematic constraint of the respective base and top; however, more than six points of Hertzian contact could be utilized in an interchangeable quasi-kinematic coupling, thereby increasing the load bearing capacity of the resulting couplings. In order to fabricate interchangeable kinematic coupling bases and tops that maintain accuracy across different base/top pairs, it is necessary to fabricate the interchangeable bases and tops from the same base/top template pairs so that the interchangeable bases and the interchangeable tops are identically replicated to the greatest degree possible.

Forming Kinematic Coupling Top Template

One embodiment of a template (20) for fabricating the kinematic coupling top (12) is illustrated in FIGS. 2a and 2b. The template (20) of this embodiment, comprises a frame providing a planar surface (T) (in this embodiment, a granite slab) and a plate (22) (in, this embodiment a steel plate affixed to the granite slab with epoxy and with three approximately circular holes (23)) arranged in a triangle (ideally, on equilateral triangle), and a planar reference structure (30) parallel to the surface (T) (this embodiment uses one or more gage blocks stacked on the granite surface to provide the planar reference structure); supports (26) for locating the top bearing elements (this embodiment uses convex surfaces, such as provided by three sets of three precision steel spheres of substantially equal diameter located in each hole (23) on the plate (22)); three preload elements (28) (this embodiment uses three sets of three spring elements) that serve to position the supports (26) away from the side of the respective hole (23) in the plate (22) and to preload each sphere so that it is in Hertzian contact with each adjacent sphere in a given support.

Equal preloading creates supports (26) each comprised of three spheres arranged in an equilateral triangle. Also, the sizes of the triangles are all sufficiently the same, to the degree the spheres are all the same diameter. Once the supports (26) have been positioned and horizontally preloaded in the holes (23), they are then equally vertically preloaded with a mass, which may comprise a steel plate with an equally distributed mass. Equal preloading creates equal Hertzian deformation at the interface of the supports and the surface (T) and places the centroids of the supports (26) on the same plane, which is also parallel to the planar reference structure (30). After preloading, the supports (26) are and then affixed in position with a fixing agent, such as an epoxy-based of adhesive agent (such as potting compound DP-270, distributed by 3M Industrial Adhesives and Tapes, 3M ID No. 62-3262-1435-0). After affixing the supports (26) to the frame, the template is ready to be used to form a kinematic coupling top (12).

Forming Kinematic, or Quasi-Kinematic, Coupling, Top from Template

One embodiment of a kinematic coupling top (12) formed from the top template, FIGS. 2a and 2b, is illustrated in FIGS. 1a and 1b. It is comprised of a plate (13) (in this embodiment a circular plate comprised of a hard material, such as steel) with three approximately circular cut-outs, such as through-holes (11) arranged in a sufficiently equal pattern as the holes on the template, three bearing elements (18) of substantially equal size (in this embodiment ultra-precise spheres also formed of a hard material, such as steel) and two work-surfaces (S) and (U) (in this embodiment precision ground surfaces), where the surfaces are substantially parallel to one another.

The fabrication of the kinematic coupling top (12) comprises the steps of placing the kinematic coupling top work surface (U) on the planar reference structure (30), locating each through-hole (11) over the center of the three supports on the template (26), placing a bearing element (18) in each through-hole (11) so that it rests upon one of each of the supports (26), adjusting the plate (13) so that no hearing element (18) is in contact with the plate and each hearing element rests independently upon a support (26), which consists of three spherical shapes. The bearing elements for this embodiment are spherical shapes, and thus have three axes about which the geometry is axisymmetric; therefore to constrain the spheres kinematically, only three points of contact are required. The bearing elements are then equally pre-loaded so that they are in equal Hertzian deformation and, due to the fabrication process of the template, the center of the spherical surface lie on a plane parallel to the work surface (U). The bearing elements are then affixed to the plate with a fixing agent (in this embodiment, epoxy) and the top (12) is ready for use.

In the most preferred embodiment, work surfaces (U) and (S) are fabricated so as to be parallel with a plane intersecting the centers of the bearing elements (18). This allows the work surfaces (U) and (S) of a top and base to be parallel when mated, given that the base meets the same criterion.

For parallelism, the spheres on a given top must be of substantially equal diameter, and for accuracy spheres on every top must be of substantially equal diameter. This creates tops that have accurate positioning of the bearing elements and a work surface parallel to the bearing elements. If the positional accuracy in the direction orthogonal to the work surface is not important, which is the case for most applications, the spheres on every top need not be of substantially equal diameter, and then only the spheres on each top need to be of substantially equal diameter.

Forming Kinematic, or Quasi-Kinematic, Coupling Base Template

One embodiment of a template (20) for fabricating the kinematic coupling base (14) is illustrated in FIGS. 4a and 4b. This template comprises a frame that contains a surface (T) (in this embodiment a granite slab) and a plate (22) (in this embodiment a steel plate affixed to the granite slab with epoxy and with three approximately rectangular cut-outs, such as through-holes (23)) arranged in an equilateral triangle and the holes are oriented so that one side of the rectangle is substantially parallel to a line drawn from the centroid of the rectangle to the centroid of the triangle comprising the rectangles, and a planar reference structure (30) that is substantially parallel to the surface (T) (in this embodiment gage blocks placed on the granite surface); supports for locating the bearing elements (18) (in this embodiment three sets of six precision steel spheres of sufficiently equal diameter located in each hole on the plate); three preload elements (28) (in this embodiment three sets of ten spring elements) that serve to position the structures comprising the supports (26) away from the side of the respective hole in the plate and to preload each sphere so that it is in Hertzian contact with each adjacent sphere in a given support.

Equal preloading creates supports (26) each comprised of six spheres arranged in an array of two rows and three columns, and the sizes of the arrays are all similar, to the degree the spheres are each the same diameter. Once the elements forming the supports (26) have been positioned and horizontally preloaded in the holes (23), they are then equally vertically preloaded (for this embodiment an equal masses were used). Equal preloading creates equal Hertzian deformation at the interface of the elements of supports (26) and the surface (T) and places the centroids of the supports (26) on the same plane, which is also parallel to the planar reference structure (30). After preloading, the supports (26) are then affixed in position with a fixing agent (such as an epoxy-based adhesive). After affixing the supports (26) to the frame, the template is ready to be used to form a kinematic coupling base (14).

Forming Kinematic, or Quasi-Kinematic, Coupling Base from Template

The first embodiment of a kinematic coupling base (14) formed from the base template, FIGS. 4a and 4b, is illustrated in FIGS. 1a and 1b. It is comprised of a plate (13) (in this embodiment a steel plate), three bearing elements (18) of sufficiently equal size (in this embodiment truncated, ultra-precise cylinders arranged to form a vee-groove) and two substantially parallel work-surfaces (S) and (U) (in this embodiment precision ground surfaces that are parallel to one another).

The fabrication of the kinematic coupling base (14) comprises the steps of placing a bearing element (18) so that it rests upon one of the supports (26), placing the kinematic coupling bottom work surface (U) on the planar reference structure (30), and providing the hearing elements (18) so that none is in contact with the plate (13) and each bearing element rests independently upon a support (26). The bearing elements (18) are then equally pre-loaded so that they are in equal Hertzian deformation and, due to the fabrication process of the template, the axes of the cylinders forming the bearing elements (18) lie on a plane parallel to the work surface (U) and the distance between the axes of cylinders on each support (26) is the same. The bearing elements (18) are then affixed to the plate (13) with a fixing agent (in this embodiment, epoxy) and the base (14) is ready for use.

In the most preferred embodiment surfaces (U) and (S) are parallel with plane comprising the axes of the cylinders and the cylinders are positioned in an accurate manner. The parallelism is achieved by using cylinders of substantially equal diameter and positioning the two cylinders so that they are equidistant for each bearing element (18). To achieve accurate positioning the cylinders must be of substantially equal diameter and they must be kinematically constrained. Cylinders have one axis about which the geometry is axisymmetric and the surface is straight along that same axis. Therefore, to constrain the cylinders kinematically, only four points of contact are required, which is achieved by the contact of four spherical shapes on the template for forming the base (14). If the positional accuracy in the direction orthogonal to the work surface is not important, which is the ease for most applications, the cylinders on every top need not be of substantially equal diameter, and then only the cylinders on each top need to be of substantially equal diameter.

Forming Flippable Kinematic, or Quasi-Kinematic, Coupling Top

According to a further aspect of the disclosure, it is also proposed to provide a kinematic coupling in which the top (12) includes bearing elements that project in opposing directions, as shown in FIG. 1a. Specifically, it should be appreciated that, in the preferred embodiment illustrated, the bearing elements (18) in the form of spherical balls associated with the top (12) project from one side of the plate (13) in a first direction and from the opposite side in a generally opposite, second direction. Most preferably, these bearing elements are symmetrical about the plane comprised of the center of the spherical surface of the bearing elements (18), so as to render it capable of being inverted, or flipped, relative to the base (14).

Accordingly, the top (12) in position on a base (14), may be removed, rotated 180° about an axis through the center of the spherical surface of one of the bearing elements (18) and orthogonal to the line comprising the center of the spherical surface of the other two bearing elements (18), and replaced on the same or a different base, as may be desirable for increased efficiency in the course of a particular process. If the triangle is an isosceles triangle with the two equal sides meeting at the bearing element (18) about which rotation occurs, the accuracy of the locations of the spheres is maintained as the top is flipped.

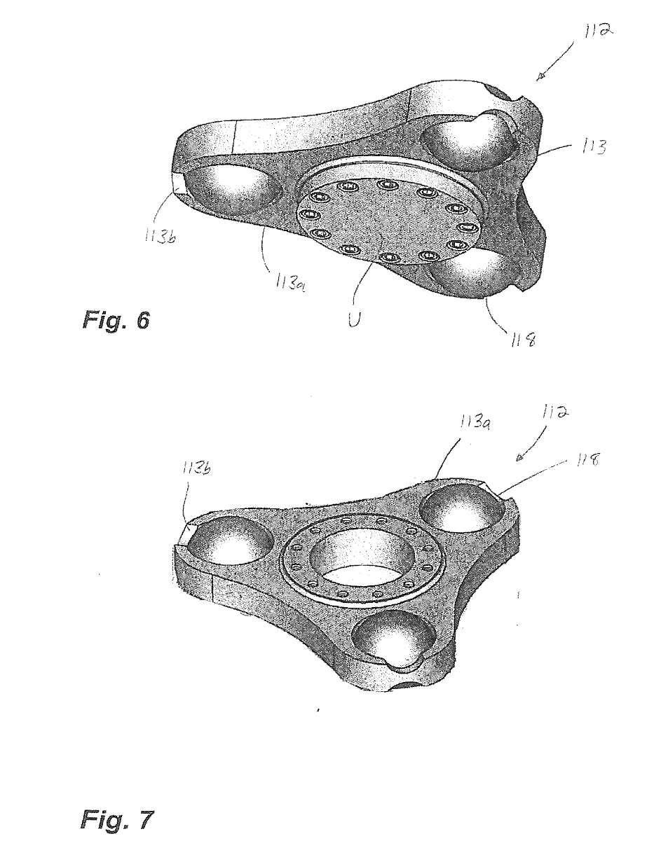

FIGS. 6-7 show a further embodiment of a “flippable” top (112) including a substantially planar (e.g., precision ground) reference surface (U) along at least one side. In this embodiment, the plate (113) includes three through-holes (113a) for the bearing elements (118) that may be fixed in place according to the previously described procedure. The plate (113) has cut-outs (113b) adjacent each hole (111) for access of the exterior surface of the bearing elements (118). The access afforded can be used to sense the location of the corresponding bearing element (118), such as using a measuring instrument (not shown).

As can be further appreciated, the shape of the plate (113) of this embodiment is generally triangular, and thus uses minimal material (and may also be inwardly curved around the lateral sides for a further reduction). This shape provides ready access of/be space around the top (112) when mounted to other coupling components or devices. Also, a minimum amount of material exists outside the triangle comprised by the bearing elements (118) and therefore the forces that can be applied outside the triangle are minimized. This increases stability and, hence, repeatability. This also minimizes weight and maximizes natural frequency.

Forming Kinematic, or Quasi-Kinematic, Coupling Base Using Top as Template

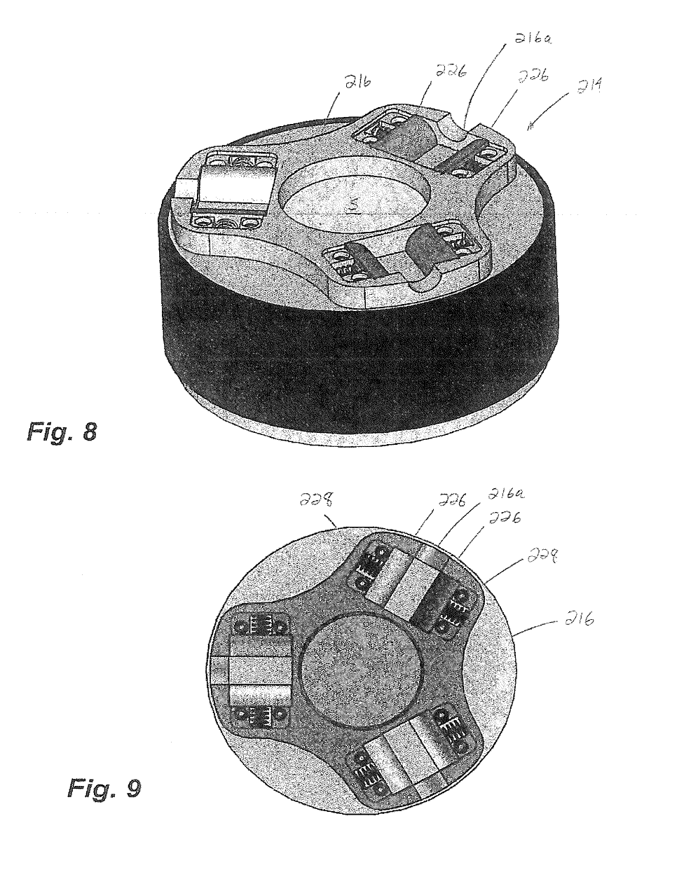

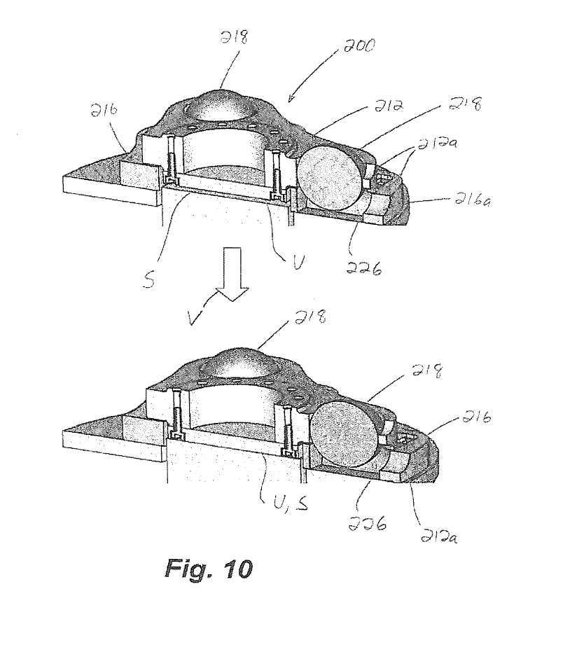

Referring now to FIGS. 8-10, another aspect of the disclosure relates a template (200) for forming a base (214) for use in a kinematic or quasi-kinematic coupling. The template (200) may take the form of a top (212), which may be similar or identical to those described previously (including possibly top (12)). The top (212) includes supports in the form of bearing elements (218) (only two shown in FIG. 10 in view of cutaway depiction) and a substantially planar reference surface (U). These bearing elements (218) may comprise ultra-precision (i.e., small surface finish and small diameter variation) spherical elements fabricated from a hard material (e.g., 440C stainless steel), but other forms may be used, including as described elsewhere in this disclosure.

The base (214) includes a plate (216) carrying a plurality of hearing elements (226) (in the illustrated embodiment, arranged in groups of opposed pairs forming a generally triangular pattern) and a substantially planar reference surface (S). To achieve the desired repeatability and stiffness, these bearing elements (226) should be hard, smooth, stiff, and be of such geometrical profile (curvature or straight shape) to create single point (or line or area, optionally) that intimately contacts each bearing element (218) of the top (212). In the illustrated embodiment, the bearing elements (226) comprise ultra-precision quarter-round cylindrical shapes fabricated from a hard material (e.g., carbide), but other forms may be used, including as described herein.

Associated with each bearing element (226) of the base (214) is a preload element (228). These preload elements (228) position the bearing elements (226) before they are located in the appropriate position as a result of engaging the corresponding bearing element (218) and being fixed in place. In the illustrated embodiment, the preload elements (228) comprise ultra-precision compression springs.

With reference now to FIG. 10, which is cutaway to better illustrate the components at issue, forming of the base (214) may be accomplished by arranging the top (212) such that the corresponding top bearing elements (218) engage the base bearing elements (226) and the substantially planar surfaces (U, S) are adjacent each other. The top (212) is then preloaded in a direction orthogonal to the plane of the surfaces (U, S) so that the bearing elements (218, 226) are in equal Hertzian deformation as a result of the preload elements (228) providing a substantially equal force. This provides uniform contact during actuation, and may be done using any selected manner of providing the necessary force (manual, magnetic, pneumatic, or hydraulic, as examples).

The result, as shown in the lower portion of FIG. 10, is that the reference surfaces (U, S) are brought into contact. Once preloaded, a fixing agent may be used to fix the location of the bearing elements (226). The fixing agent may be an adhesive, such as the epoxy previously described.

The base (214) is thereby formed using the top (212) as a template (200), and the two structures as shown can be used together to form a kinematic coupling. In this regard, the plate (216) of the base (214) may include notches (216a) arranged to align with notches (212a) in the top (212), when mated, and thus provide access for a measuring instrument or the like. By forming multiple bases (214) using the same top (212) in this manner, they become freely interchangeable without loss of positional accuracy or repeatability.

Forming Kinematic, or Quasi-Kinematic, Coupling with Single Degree of Freedom

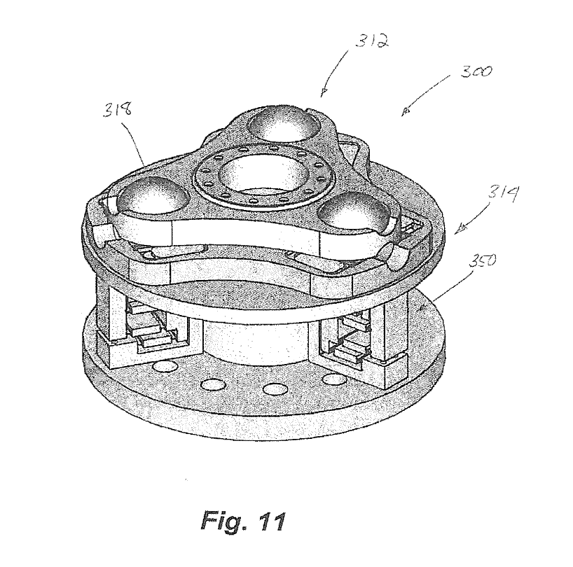

Turning to FIGS. 11-15, another embodiment disclosed herein relates to a coupling (300) adapted to provide a linear, single degree of freedom that is orthogonal to the mating surfaces of a top (312) and base (314). This degree of freedom permits the reference surfaces of the coupling (300) one reference surface (U) on the top (312) and the other surface (S) on the base (314)) to be clamped together with high precision, creating high stiffness while maintaining orthogonality and repeatability. The base (314) having this feature may be used to retain a top (312) for external processing using any number of manufacturing, assembly or measurement processes or to perform operations such as punching, printing, embossing, or any number of other operations by bringing the two surfaces (U, S) together in a repeatable manner.

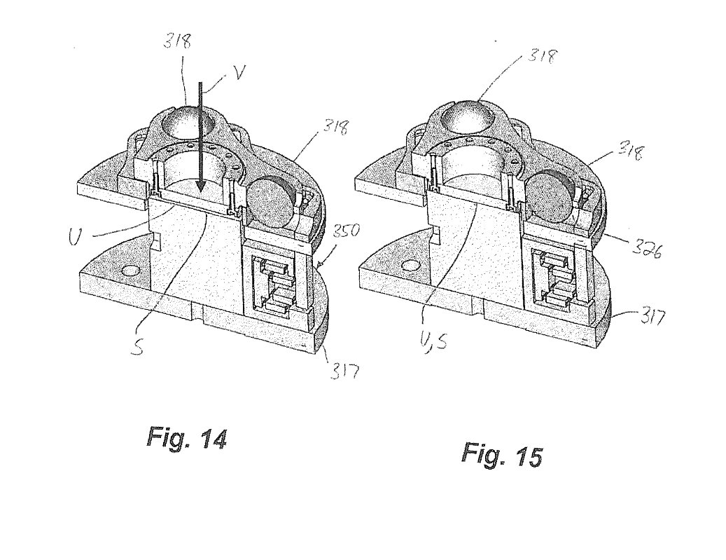

With combined reference to FIGS. 11 and 12, forming of the coupling (300) may be accomplished by arranging the top (312) and base (314) such that the top bearing elements (318) engage the base bearing elements (326). The base bearing elements (326) may be are arranged in opposed pairs within cutouts (315a, 315b, 315e) in a plate (315). Each base bearing element (326) is also associated with a preload element (328). The top (312) is then preloaded in a direction corresponding to the single degree of freedom (in FIG. 14, the vertical direction V) to establish the desired equal Hertzian deformation at the points of contact. This may be done using a manual, magnetic, pneumatic, hydraulic force, or others without limitation.

The result, as shown in FIG. 15, is that the reference surfaces (U, S) are brought into contact. A locking element, such as a magnetic chuck or vacuum, may then be used to lock the top (312) in place. Once preloaded and locked in place, a fixing agent may be used to fix the location of the preload elements (328). The fixing agent may be an adhesive, such as the epoxy described in the foregoing passage, but could also take the form of a mechanical fastener (e.g., a screw).

As should be appreciated, the single degree of freedom can be achieved by using any type of dynamic bearing (350) (meaning a bearing permitting relative movement between two associated parts), including for example, a roller bearing, spring, hydrostatic bearing, air bearing, or the like, as long as the selected structure provides sufficient stiffness in relation to the other five degrees of freedom. As shown, this bearing may be arranged between the plate (315) and a stable support structure, such as for example another plate (317). In any case, the degree of freedom is linear and thus not sensitive to the orthogonality to the surfaces (U, S), and rotations of these surfaces do not occur. The surfaces start parallel and remain parallel until mated. Although it is preferable for the dynamic bearing element (350) to associate with the base (314), an alternative is to associate this bearing element with the top (312).

An alternative to the illustrated arrangement is to use a different shape (e.g., a triangular right prism), instead of quarter rounds, for the base bearing elements (326). Also, various materials can be used for these elements (326), including but not limited to 440C stainless steel, silicon nitride, silicon carbide, and tungsten carbide. Also, the bearing elements (318) of the top (312) may comprise V-grooves and the bearing elements (326) of the base (314) may comprise spheres.

Dual Sided Base for Kinematic, or Quasi-Kinematic, Coupling

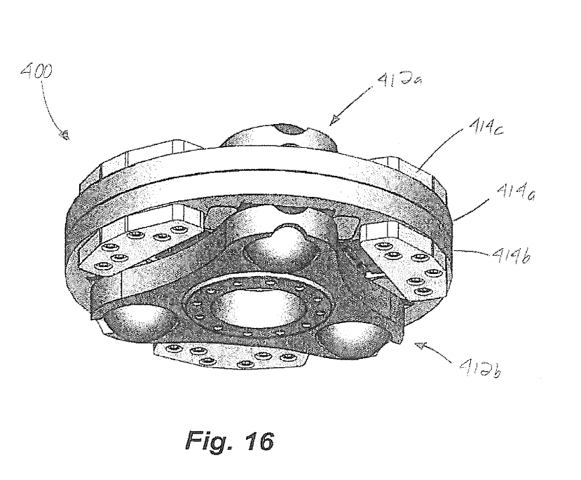

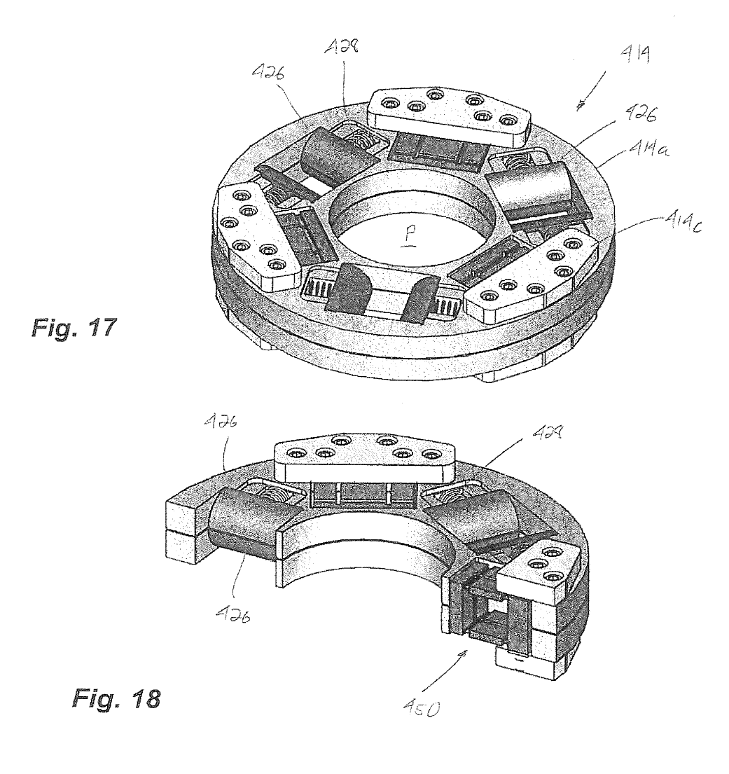

A further embodiment of a coupling (400) is shown in FIGS. 16-20, which relates to the positioning and alignment of two parts, workpieces, or surfaces in space. Specifically, the present coupling (400) enables the stacking and flipping of kinematically coupled surfaces in groups of two or more in a repeatable and accurate manner while providing one or more single degrees of freedom to bring the objects together without a significant loss in repeatability and accuracy. This may allow for simultaneous processing of two different workpieces associated with the coupling (400).

Referring now to FIG. 16, the illustrated embodiment of the coupling (400) comprises at least two tops (41.2a, 412b) (for purposes of this disclosure, “top” refers to a counterpart for a base to form a coupling, and not necessarily the highest or ultimate point or the relative spatial orientation) and a base (414) adapted to join the tops together as a unit. The base (414) comprises two base plates (414a, 414b), each having bearing elements (426) for engaging the bearing elements (418) of the respective tops (412a, 412b) and a passage (P) through which associated substantially planar reference surfaces (U, S) may contact each other.

These plates (414a, 414b) are nominally separated by a gap (G) maintained by a dynamic bearing (450), such as a flexure in the illustrated embodiment. This bearing (450) provides a single degree of freedom in a direction generally orthogonal to corresponding reference surfaces (U, S) of the tops (412a, 412b). When a sufficiently large force is applied in the direction of this bearing (450), the base plates (414a, 414b) may thus move towards one another until a hard stop is reached, which is before these plates actually contact one another. The dynamic bearing (450) may be attached to the plates (414a, 414b) using bolted-on brackets (414c), but any other means of joining may be used.

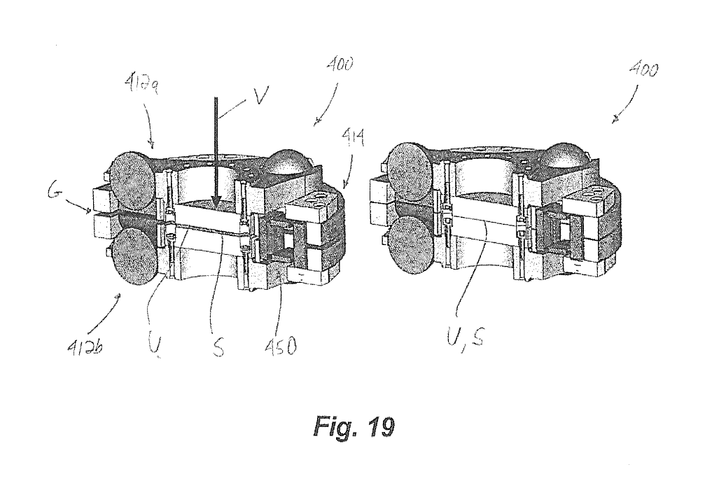

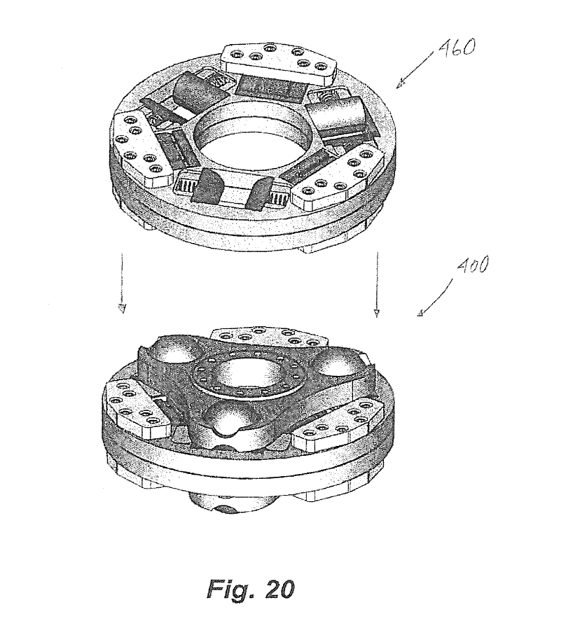

In forming this coupling (400), a single top (414a, 414b) is placed on either side of the base (414) with the planar reference surfaces (U, S) facing one-another. A force is then applied to the tops (412a, 412b) such that the dynamic bearing element (450) on the base (400) deflects and the two surfaces (U, S) are brought together before the stopping point of the bearing element is reached, as shown in FIG. 19. As should be further appreciated from FIG. 20, a further base (460) identical to base (400) may be added to the combination, and further tops can be stacked and brought together using method described above without significant loss of alignment.

Method of Forming Kinematic, or Quasi-Kinematic, Coup Dual-Sided Base

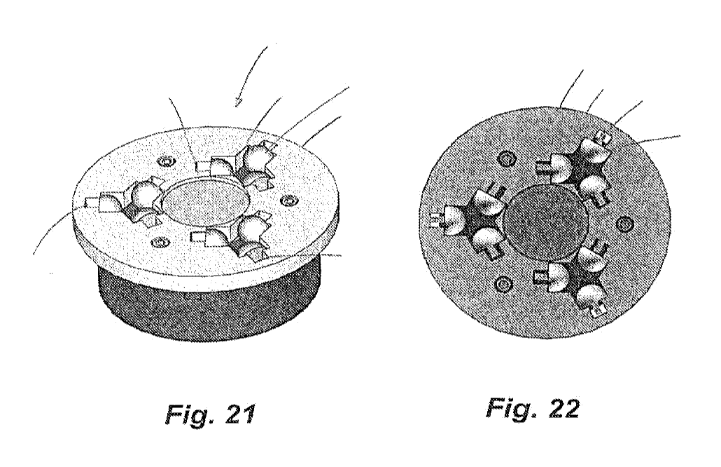

Another aspect of the disclosure relates to an apparatus method of manufacturing the two-sided base (400), which is now described with reference to FIGS. 21-31. As perhaps best understood from FIGS. 21-22, the template (500) comprises a removable plate (502). The plate (502) includes cut-outs (502a, 502b, 502c) for placement of the supports (516), which are arranged in groups of three. Corresponding preload elements (518), such as ultra-precision compression springs, are associated with the individual supports (516). The supports (516) may comprise three ultra-precision spherical structures fabricated from a hard material (e.g., tungsten carbide).

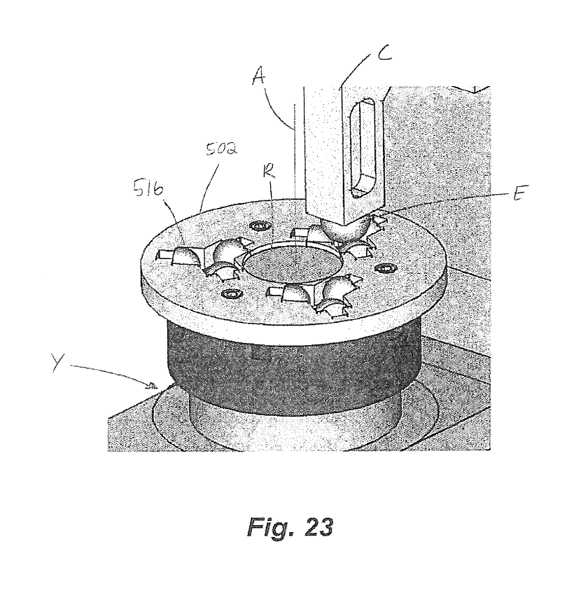

As shown in FIG. 23, the plate (502) carrying the supports (516) and associated preload elements (518) may be placed on a precision rotary element (Y), which preferably comprises a precision, high-resolution rotary stage having a rotation axis (A) orthogonal to a template reference plane (e.g., a precision ground flat surface (R)). A reference element (E) is oriented relative to the plate (502) for contacting the supports (516). This element (E) preferably comprises an ultra-precision spherical structure fabricated from a hard material and carried by a carrier (C) movable in a linear direction aligned with axis (A). The reference element (E) in this embodiment has a similar shape and size as the supports (516). The three supports (516) grouped together thus create a kinematic reference frame for constraining the reference element (E). Since each support (516) is symmetric about the three axes of rotation, only the three linear degrees of freedom need to be constrained.

In use, a selected grouping of the supports (516) is loaded against the reference element (E) using the preload elements (518) that are deflected uniformly. During this deflection, the corresponding cutouts (502a, 502b, 502e) in the plate (502) provide guides for the supports (516). Preferably, the cutouts (502a, 502b, 502c) are oriented symmetrically about the reference element (E). The individual elements of the supports (516) are then fixed in place with a fixing agent, such as a dimensionally stable epoxy that fills in around the gaps between the plate (502) and the supports.

Once fixing is complete, the reference element (E) is retracted with the carrier (C). The rotary element (Y) is incremented to align the next group of supports (516). The process is repeated to fix the supports (516) of the template (500), which are shown as being located at 0′, 120°, and 240′, with 0° referencing to the angular position of the first set of supports (516).

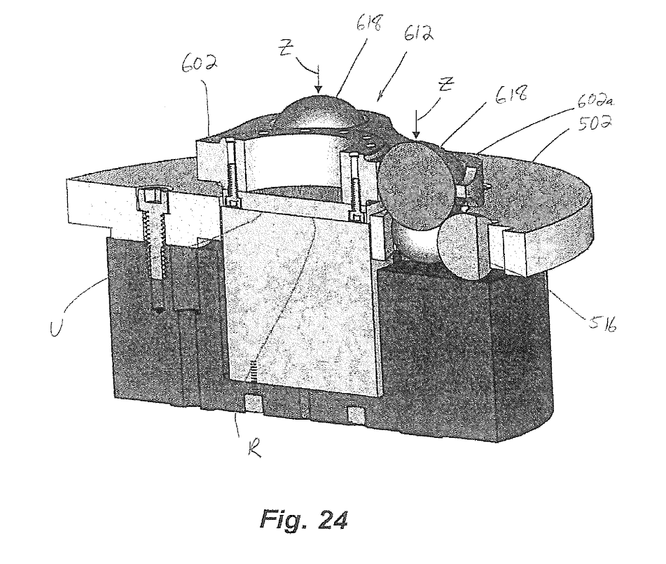

With reference to FIG. 24, at least one, and preferably a plurality of tops (612) may be formed using the template (500). This is done by placing a bearing element (618) on each group of the supports (516) of the plate (502) of template (500) and preloading the bearing elements in a direction orthogonal to the reference surface (R) (see action arrows Z). These bearing elements (618) preferably comprise ultra-precision spherical elements fabricated from a durable material (e.g., 440C stainless steel). To create the preloading, a mass of equal weight may be placed on top of each of the bearing elements (618). This results in each the bearing elements (618) being kinematically constrained about its centroid due to three points of contact, because the three rotational degrees of freedom do not need to be constrained. Consequently, the centroids of these bearing elements (618) form an equilateral triangle.

Next, a plate (602) is positioned by mating its substantially planar surface (U) with the template reference surface (R). The plate (602) includes oversized holes (602a) for receiving the bearing elements (618) without making contact. The bearing elements (618) are then attached to plate (602) using a fixing agent, which may be a dimensionally stable epoxy. Once the epoxy has cured, the preloading is removed and the top (612) is ready for use.

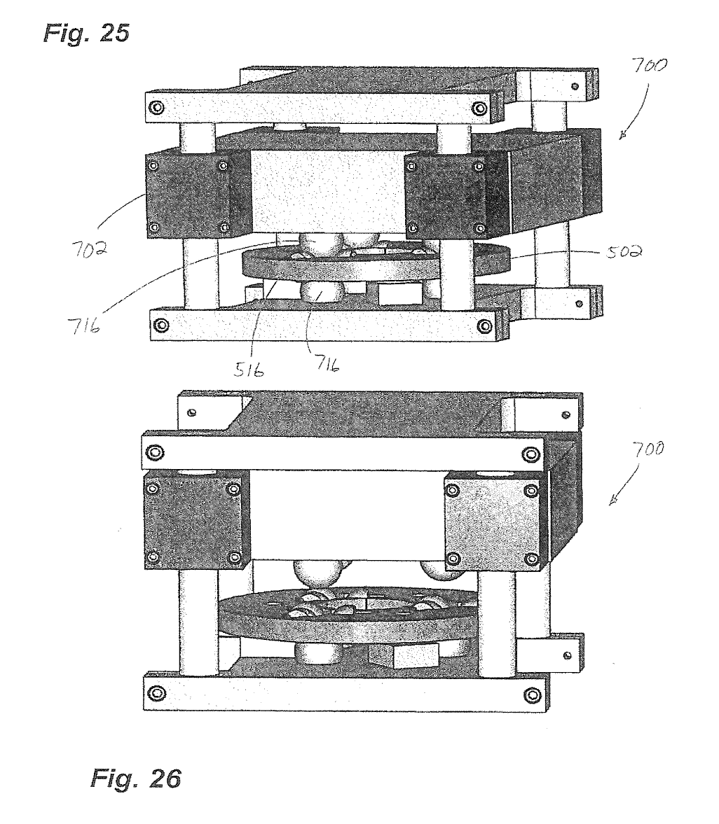

The template (500) may also be used to form a base template (700) for forming a two sided base, such as base (414). Specifically, with reference to FIGS. 25 and 26, a bearing (which may take the form of a sliding plate (702)), is positioned over the plate (502) of the template (500) such that corresponding supports (716) are uniformly preloaded against the supports (516) using the associated preload elements (718), such as ultra-precision compression springs (see FIG. 28). As above, the supports (716) may comprise ultra-precision spherical structures fabricated from a hard material (e.g., 440C stainless steel). Although a sliding plate (702) is shown, the bearing may comprise any arrangement having high stiffness in all degrees of freedom except the one orthogonal to the plane including the centroids of the supports (716).

As shown in FIG. 25, the supports (716) are then fixed in place. The plate (702) serving as the bearing for the template (700) is actuated to separate the supports (716) of the template (700) from the supports (516) of the template (500) (FIG. 26). The plate (502) may then be removed and returned to the template (500), leaving the base template (700) ready for use.

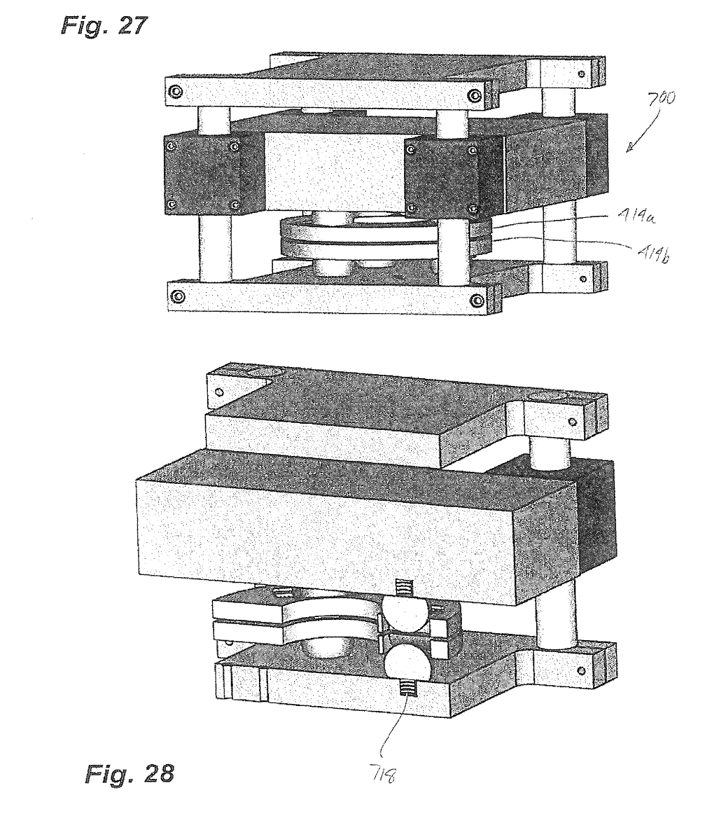

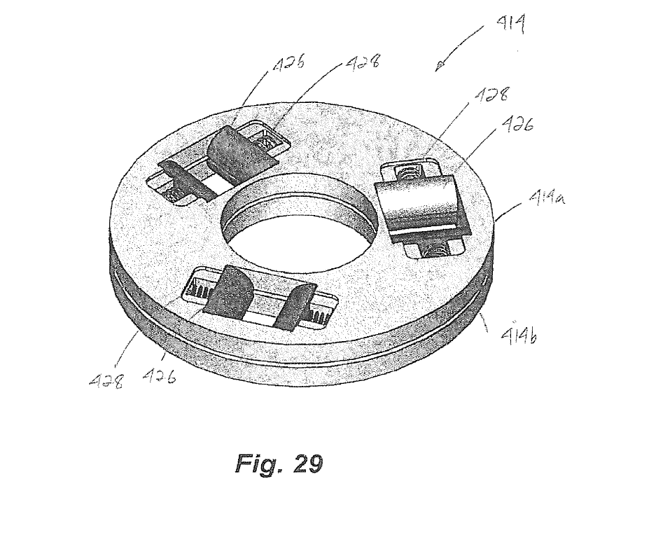

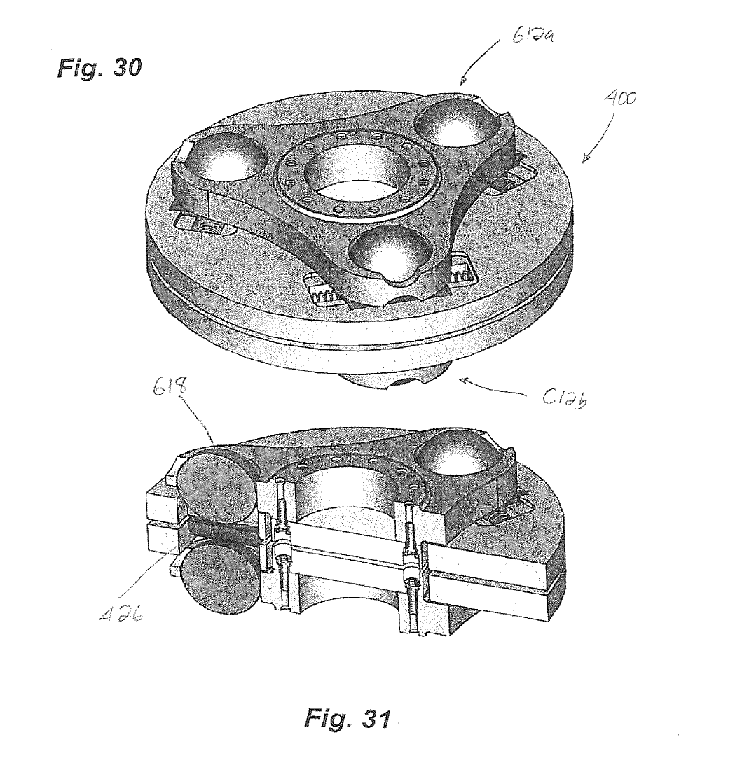

The components for forming the two-sided base (414) may now be assembled. Referring to FIGS. 27 and 28, the base plates (414a, 414b) including the bearing elements (426) (which may comprise quarter rounds, as noted above) and preload elements (428) (see FIG. 29) are placed in the template (700). The plate (702) is actuated to locate the bearing elements (426) to the position used during fabrication of the template (700). This creates uniform Hertzian contact stress at all twelve contact points. The bearing elements (426) of the base (414) are then fixed in place by applying a fixing agent (e.g., dimensionally stable epoxy) to form a bond with the corresponding the plates (414a, 414b). Once the epoxy has cured, the support (620) is retracted and the base (414) is removed and ready for use (FIG. 29) for receiving tops (612a, 612b) (FIGS. 30-31).

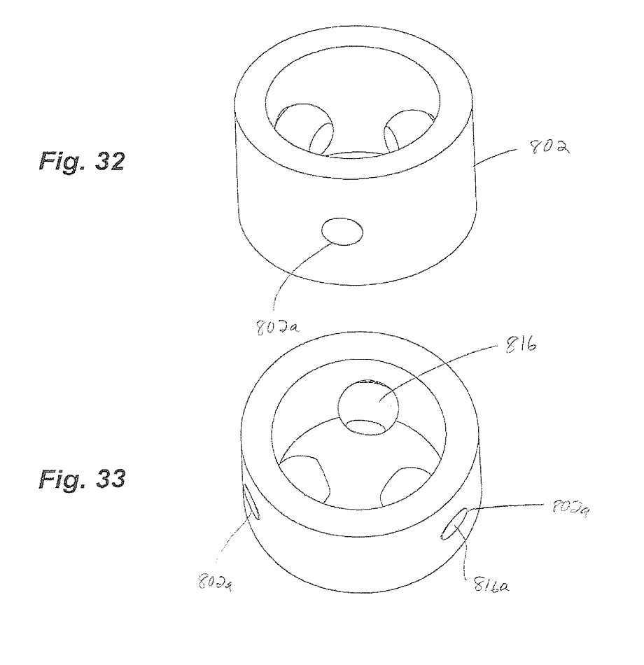

Various modifications are possible in light of the above teachings. For example, referring now to FIGS. 32-47, various alternate embodiments of tops, bases, and templates are shown. The top (812) in FIGS. 31-32 includes bearing elements (816) that may be spherical and formed of a hard material. The bearing elements (816) include stems (816a) for positioning in radially-oriented through-holes (80 in a plate (802). In the illustrated embodiment, the plate (802) comprises a tubular shape to form an open space or passage in which the spherical portions of the hearing elements reside, in use.

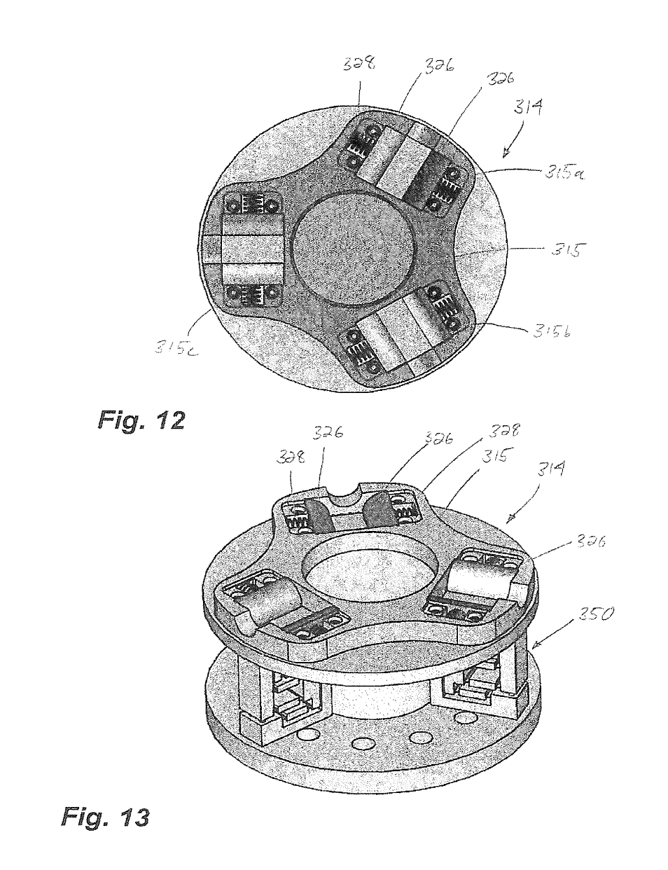

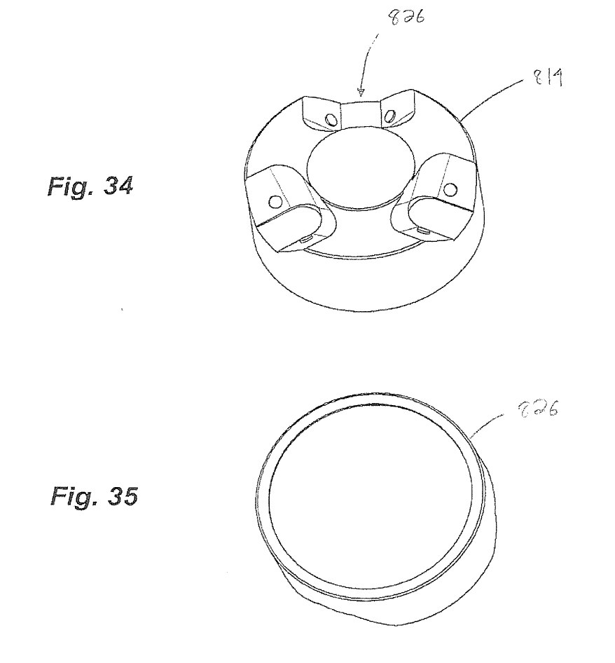

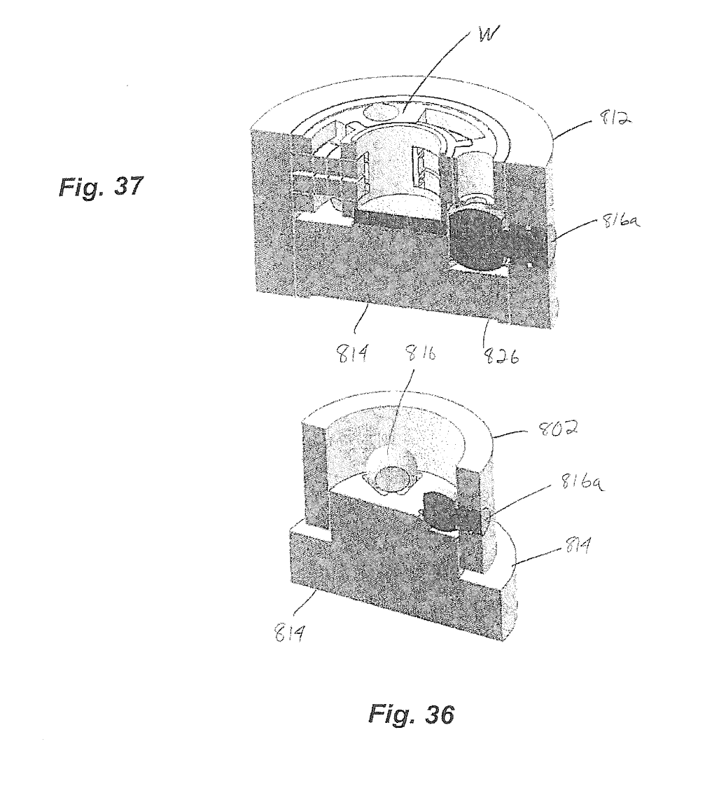

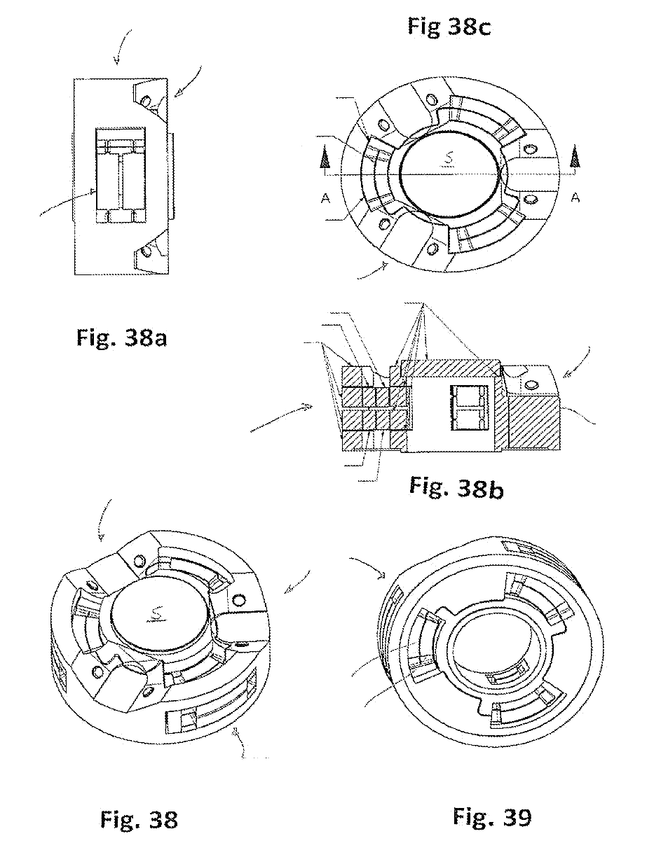

FIGS. 34-35 show a base (814) in which the bearing elements (826) are machined, rather than separately attached structures. These bearing elements (826) are still adapted for forming the desired kinematic coupling with a corresponding top, such as tops (112, 812) or any like embodiment adapted to engage the base (814) (see FIGS. 36-37, and note top (812) supporting work part (W)). FIGS. 38-39 illustrate a base (914) similar to base (814), in that the bearing elements (926) are machined in place. This base (914) further includes one or more dynamic bearings, which may comprise integrally formed flexures. As with the embodiment shown in FIGS. 12-13, this provides a coupling formed using the base (914) with a single degree of freedom.

FIGS. 38a, 38b, and 38c provide further detail of the base (914) having a plurality of circumferentially spaced flexures (950) and bearing elements (926). Each flexure (1450) may include a plurality of beams (950a, 950b, 950c, 950d) for creating a floating intermediate platform (F) providing the bearing elements (926) desired freedom of movement (reference character M indicates parts that move relative to stationary parts N) in a single direction, such as orthogonal to the planar surface (S). Additional details of the design of flexures of this nature may be found in Awtar, S. and Slocum, A. H., 2005, “Design of Flexure Stages based on a Symmetric Diaphragm Flexure”, Proc, ASPE 2005 Annual Meeting, Norfolk, Va., Paper No. 1803, the disclosure of which is incorporated herein by reference.

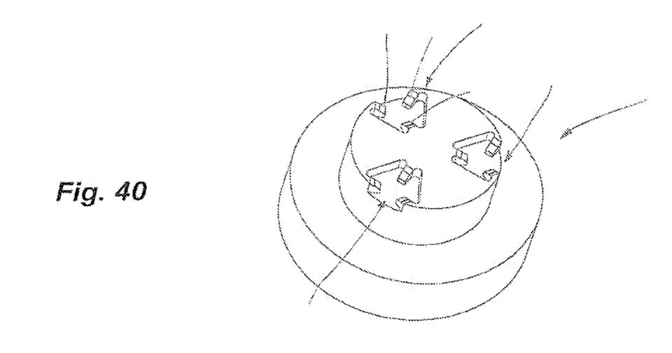

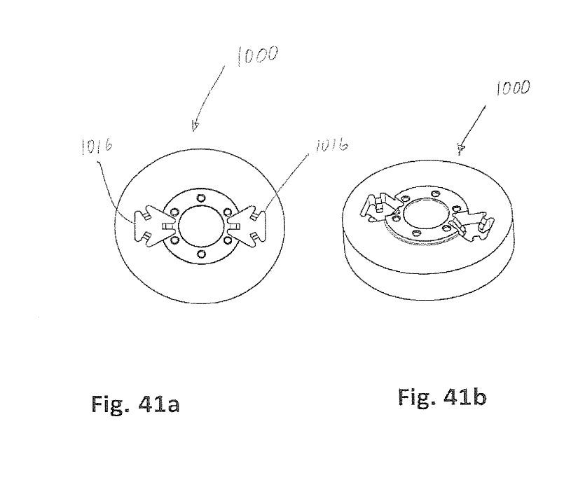

FIGS. 40, 41a and 41b illustrate a template (1000) with integral, machined supports (1016 the illustrated embodiment, each support (1016) is adapted to engage a spherical bearing element (not shown), such as by including three flats (1016a, 1016b, 1016c) arranged approximately 120° apart in a triangular pattern. The embodiment of FIG. 40 shows three supports (1016), but FIGS. 41a and 41b show that the template (1000) of this design may comprise two supports (1016), with support for a third bearing element of any top being provided by a separate structure (and possibly with at least one degree of freedom, such as for use in forming a quasi-kinematic coupling).

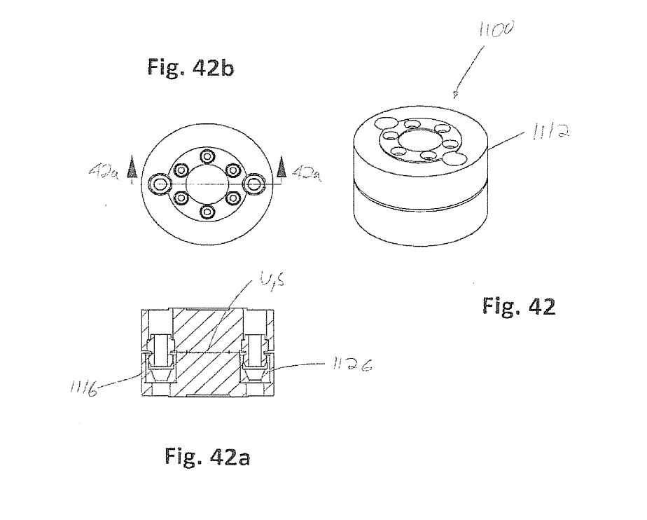

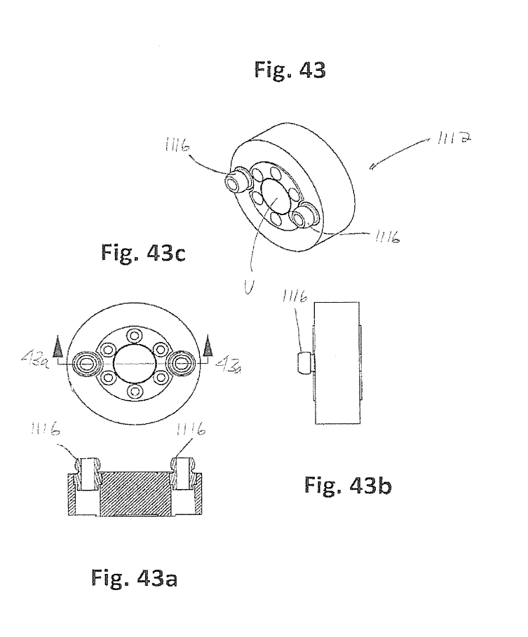

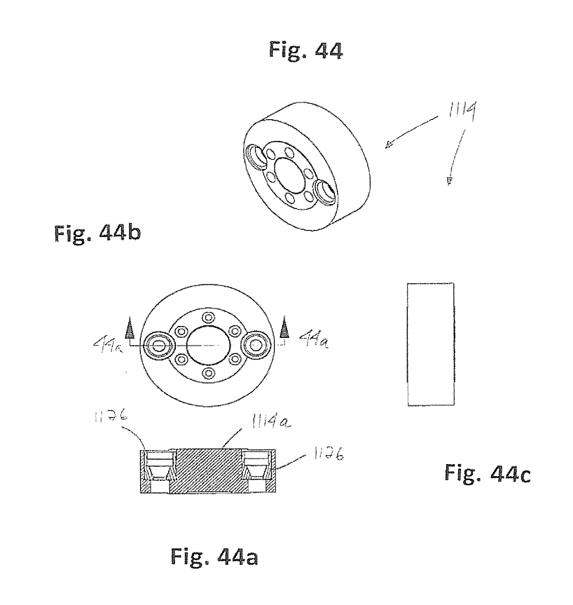

An alternative embodiment of a quasi-kinematic coupling (1100) is shown in FIGS. 42, 42a, and 42b. The top (1112) comprises two spherical elements (1116) and a flat surface (U) and the base (1114) includes two cylindrical elements (1126) and a flat surface (S). The cylindrical elements (1126) are positioned by the spherical elements (1116) and then fixed in place with respect to the base plate (1114a). FIGS. 43 and 43a-43c show the top (1112) in more detail, and FIGS. 44 and 44a-44c show the base in more detail.

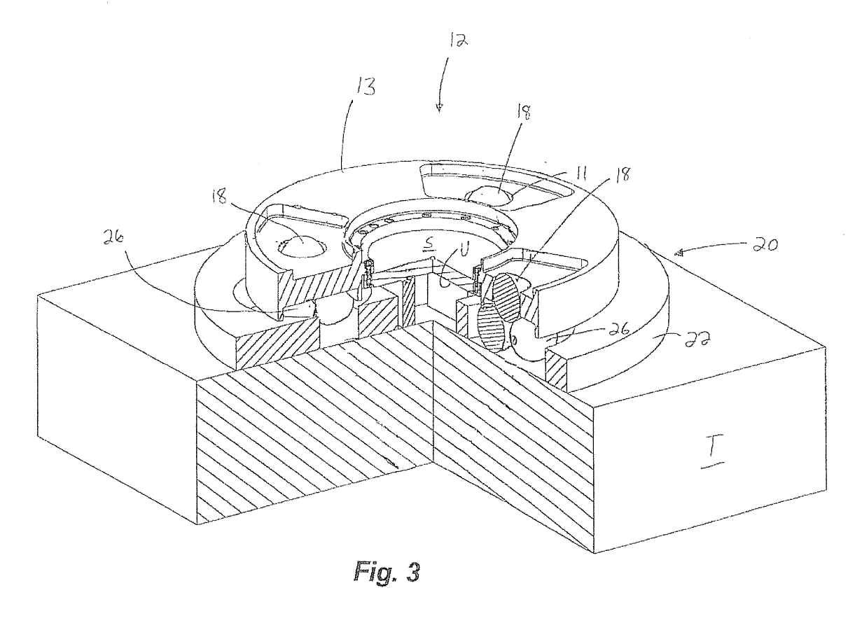

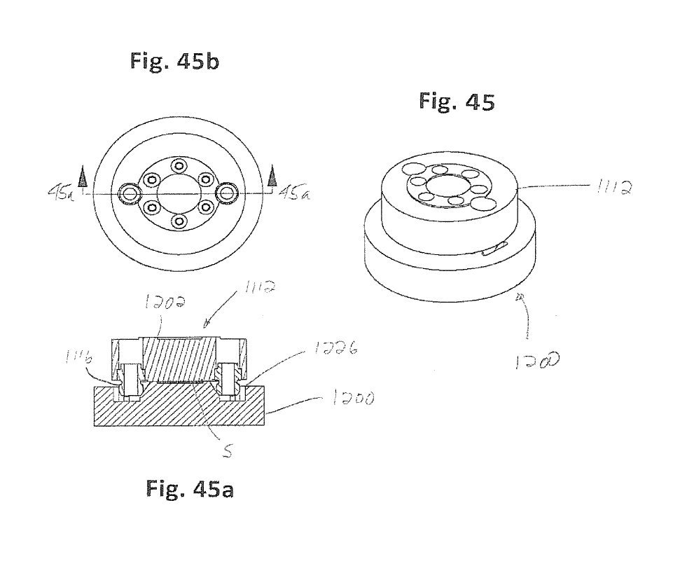

FIGS. 45 and 45a-45b show an alternative embodiment for fabricating a quasi-kinematic coupling top, such as top (1112), using a template (1200) with machined supports (1226). The top plate (1202) mates with a surface (S) on the template (1200) while the spherical bearing elements (1116) are fixed in place (see discussion corresponding to FIGS. 1-3 above).

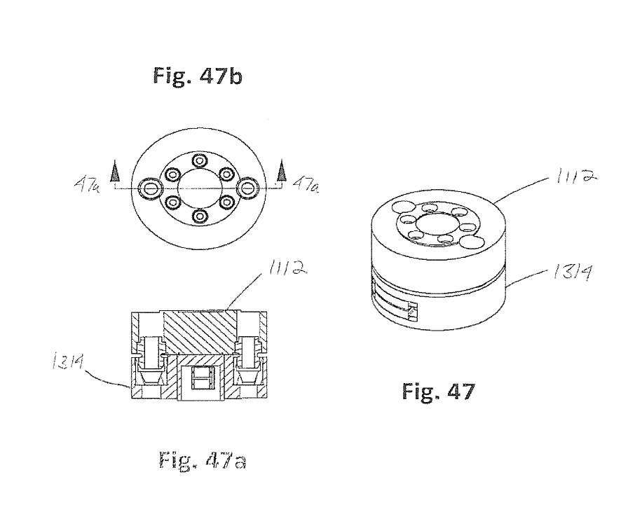

Another embodiment is shown in FIGS. 46 and 46a-46c where the base (1314) incorporating a flexure (1350) includes two cylindrical bearing elements (1326). The result is a quasi-kinematic coupling when joined with a corresponding component, such as a top (1112), as shown in FIGS. 47 and 47a-47b.

The foregoing descriptions of various embodiments of the invention are provided for purposes of illustration, and are not intended to be exhaustive or limiting. Modifications or variations are also possible in light of the above teachings. For example, although spherical shapes are preferred for use as the bearing elements and template supports (in part because of the highly consistent symmetric nature and ease of ultra-precision fabrication), these may instead comprise other shapes for providing the desired Hertzian contact, such as circular paraboloids. The bearing elements may be formed using shapes besides cylinders, such as prismatic, gothic arch, or similar structures that present two generally consistent surfaces for engaging and supporting the bearing elements of the top in the manner desired for forming a kinematic coupling. Templates for forming the top and base may also be distributed together or apart from each other. The embodiments described above were chosen to provide the best application to thereby enable one of ordinary skill in the art to utilize the disclosed inventions in various embodiments with various modifications as are suited to the particular use contemplated. All such modifications and variations are within the scope of the invention.

1. An apparatus for forming a kinematic or quasi-kinematic coupling using a top including a plurality of first bearing elements, comprising: a base for coupling with the top, said base supporting a plurality of second bearing elements adapted for engaging the plurality of first bearing elements of the top, said base adapted to move in a constrained fashion in at least one direction while coupled to the top.

2. The apparatus of claim 1, wherein the base comprises a plate having a second substantially planar surface substantially parallel to a second substantially planar surface of the top.

3. (canceled)

4. The apparatus of claim 1, wherein a dynamic bearing provides the constrained movement.

5.-8. (canceled)

9. The apparatus in claim 1, wherein pairs of the second bearing elements are arranged in three groups, each group for associating with one of first bearing elements, and the groups are arranged in a triangular pattern.

10. An apparatus for use in forming a kinematic or quasi-kinematic coupling including a base, comprising: at least one top adapted for being removably associated with the base to form the coupling, the top including a generally triangular structure supporting a plurality of first bearing elements.

11.-14. (canceled)

15. An apparatus for forming a kinematic or quasi-kinematic coupling with first component having a plurality of first bearing elements and a second component including a plurality of second bearing elements, comprising: a third component having a first side adapted for engaging at least one of the first bearing elements of the first component and a second, opposite side adapted for engaging at least one of the second bearing elements of the second component.

16. The apparatus of claim 15, wherein the first side includes a plurality of third bearing elements for engaging the first bearing elements.

17.-18. (canceled)

19. The apparatus of claim 16, wherein the second side includes a plurality of fourth bearing elements.

20. The apparatus of claim 16, wherein the plurality of third bearing elements generally form a triangle.

21. The apparatus of claim 15, wherein the third component comprises a dynamic bearing for permitting movement of the first or second component in a direction substantially orthogonal to a substantially planar surface of the first or second component.

22. The apparatus of claim 21, wherein the third component comprises a first plate connected to the second plate by the dynamic bearing.

23. (canceled)

24. An apparatus for forming first and second kinematic or quasi-kinematic couplings with first and second tops, comprising: a first base having a first side including a plurality of first bearing elements adapted for engaging the first top to form the first coupling and a second, opposite side adapted for engaging the second component to form the second coupling.

25. The apparatus of claim 24, further including a second base having a third side adapted for engaging the first or second top.

26. The apparatus of claim 24, wherein the first base comprises a dynamic bearing for permitting movement of the first or second top in at least one direction substantially generally orthogonal to a substantially planar surface of the first or second

27. An apparatus for forming first and second components of a kinematic or quasi-kinematic coupling, comprising: a first template including a plurality of first supports; and a second template including a plurality of second supports adapted for engaging the first supports of the first template; wherein the first template is used to form the first component and the second template is used to form the second component.

28. (canceled)

29. The apparatus of claim 27, wherein the plurality of second supports each include a generally spherical surface adapted for engaging the first supports.

30. The apparatus of claim 27, further including a bearing for movably supporting a portion of the second template including the second supports.

31. An apparatus comprising: a first component for forming a kinematic coupling including a plurality of bearing elements positioned in radially extending apertures, each bearing element adapted for engaging at least one of the bearing elements of a second, opposing component.

32. The apparatus of claim 31, wherein the first component is tubular and includes an opening in which the first bearing elements are positioned.

33.-49. (canceled)
